(19) United States
(12) Patent Application Publication
(10) Pub. No.: US 2024/0077750 A1
(43) Pub. Date: Mar. 7, 2024

(54) COUPLING SYSTEM BETWEEN THE FRONTAL FRAME AND THE STEMS OF GLASSES AND RELATED GLASSES

(71) Applicant: Simone MANCINI, Roma (RM) (IT)

(72) Inventor: Simone MANCINI, Roma (RM) (IT)

(21) Appl. No.: 18/269,990

(22) PCT Filed: Dec. 22, 2021
(86) PCT No.: PCT/IB2021/062179

§ 371 Date: Jun. 28, 2023

(30) Foreign Application Priority Data
Dec. 29, 2020 (IT) 102020000032588

(51) Int. Cl. G02C 5/22

(52) U.S. Cl. CPC G02C 5/2209; G02C 2200/16; G02C 2200/20

(57) ABSTRACT

A coupling system for glasses having two stems and a frontal frame includes: for each of stem, a pin made of flexible material and having two opposite ends; two blind holes made on coupling portions of the frontal frame; and a through seat made on ends of each of stems adapted to receive the pin. The second end of each stem including the pin in the respective seat is adapted to be inserted in the respective coupling portion of the frontal frame so the ends of the pin are inserted into the blind holes made therein by elastic deformation of the pin and/or of the coupling portions.

The present invention relates to a coupling system between the stems and the frontal frame of glasses.

The invention further relates to a pair of glasses comprising such a coupling system.

It is a well-known fact that glasses, whether prescription glasses or sunglasses, consist of several parts which are then assembled in the course of their production chain.

Generally, a pair of glasses comprises a frontal frame comprising two seats, into which the lenses are inserted, joined together by a bridge, which rests on the wearer's nose. The frontal frame is connected laterally to two lateral stems which allow the coupling to the same user's ears.

The frontal frame and the stems are coupled by means of micro-screw systems which require very careful processes and specialised machinery to make them.

Therefore, the mounting processes require specific machinery or at least adequate and trained labour.

This results in longer production times for glasses, higher costs and also makes it more difficult for them to be easily implemented.

Furthermore, in the event of broken glasses, a user must necessarily resort to specialist assistance for the repair and replacement of parts.

Further, with the advent of 3D printing, the Applicant proposes to use it for the production of glasses as it would allow the production of high-quality glasses and at a low cost.

However, as 3D technology to date does not allow to make certain types of elements having a too small size, standard coupling systems for glasses and micro-screws cannot be made, which prevents 3D printing from being implemented for the entire glasses production chain.

The object of the present invention is to overcome the above-mentioned drawbacks and, in particular, to devise an improved system for coupling frontal frames to stems for glasses.

A further object of the present invention is to provide a coupling system adapted to be made by 3D printing.

Another object of the present invention is to enable the entire production chain of glasses to be made by 3D printing. These and other objects according to the present invention are achieved by making a frontal frame-stem coupling system as set forth in claim 1.

Further features of the device are the object of the dependent claims.

A pair of glasses as set out in claim 8 is also an object of the present invention.

The features and advantages of the coupling system according to the present invention will be more apparent from the following description, which is to be understood as exemplifying and not limiting, with reference to the schematic attached drawings in which:

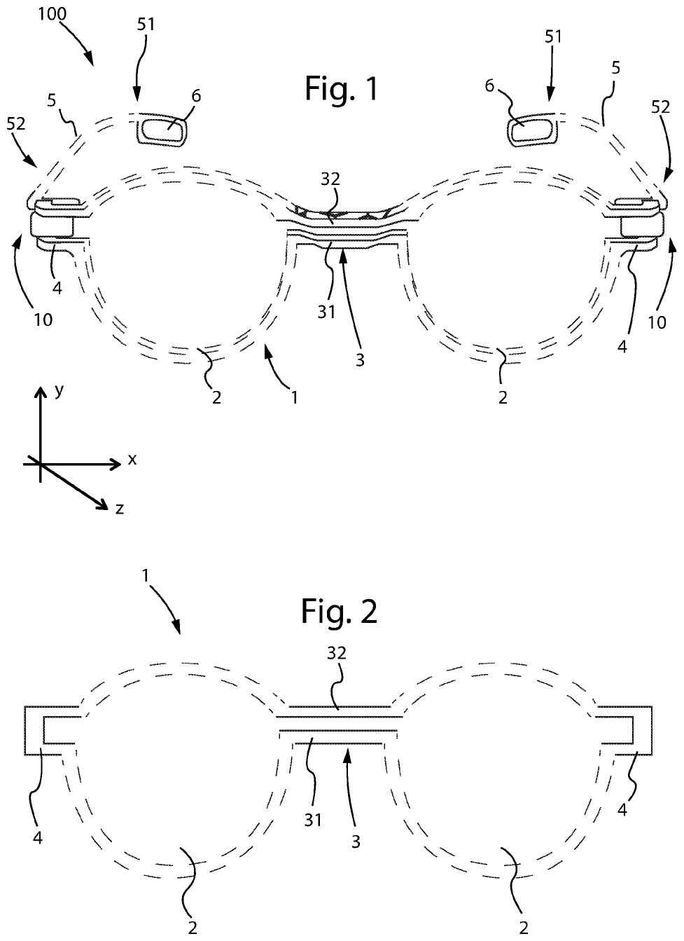

FIG. 1 is a front view of a pair of glasses according to the present invention;

FIG. 2 is a front view of the frontal frame of the glasses of FIG. 1;

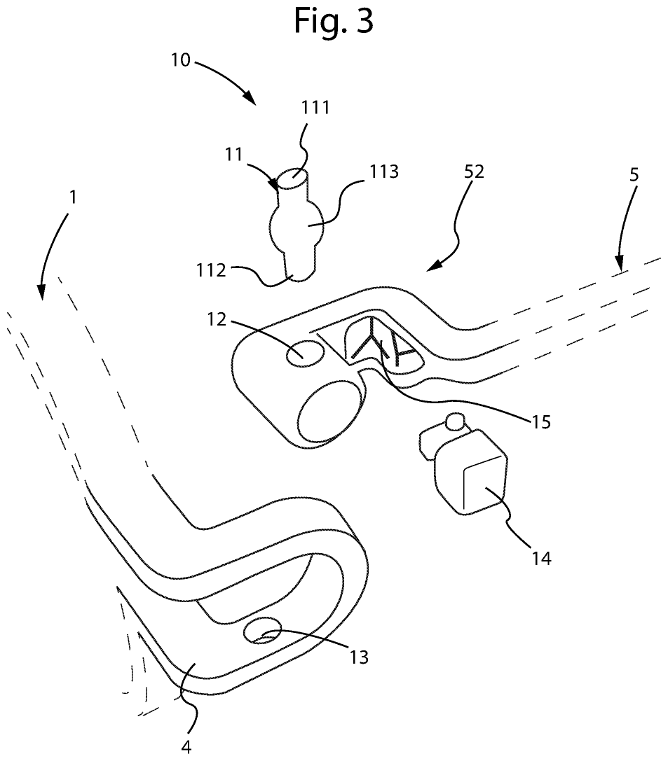

FIG. 3 is an exploded perspective view of a detail of the coupling between the stems and the frontal frame of the glasses of FIG. 1 according to the present invention;

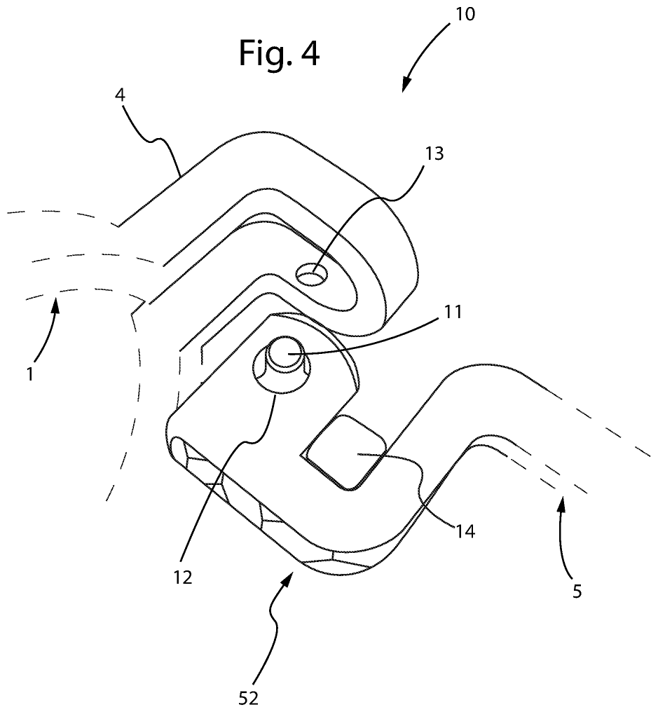

FIG. 4 is a semi-exploded perspective view of the coupling of FIG. 3;

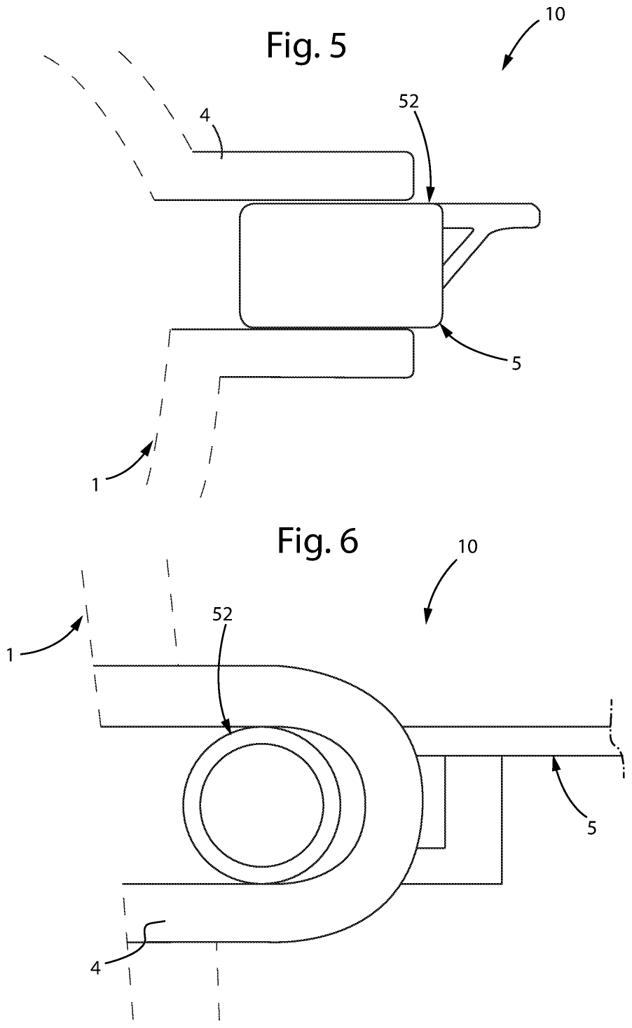

FIG. 5 is a frontal view of the frontal frame-stem coupling of FIG. 3;

FIG. 6 is a side view of the coupling of FIG. 5;

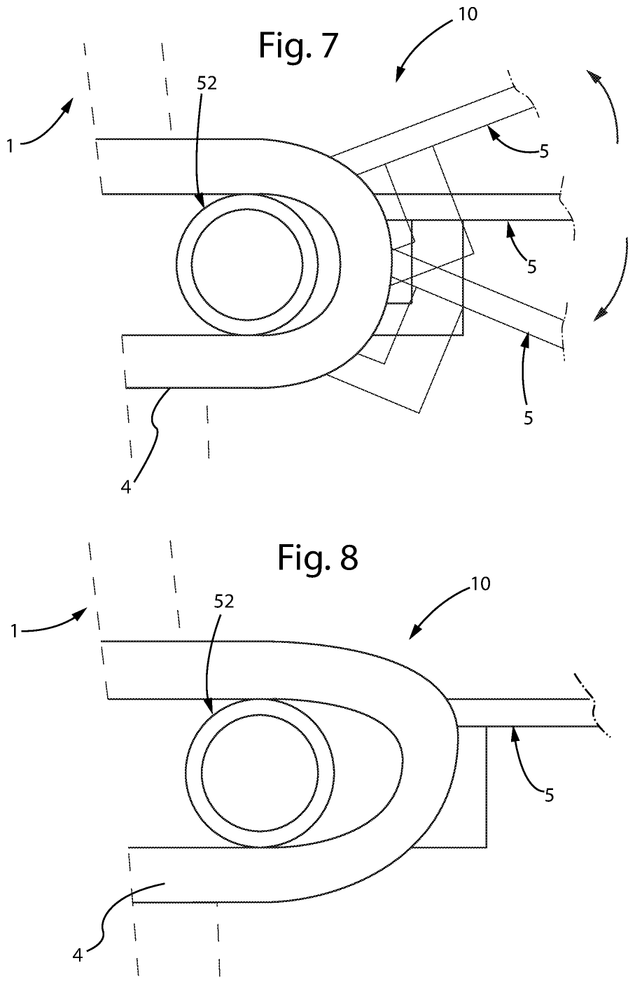

FIG. 7 is a side view of the coupling schematically showing a movement of the stem on the frontal frame;

FIG. 8 is a detailed side view of a second variant of the stem and frontal frame coupling according to the present invention;

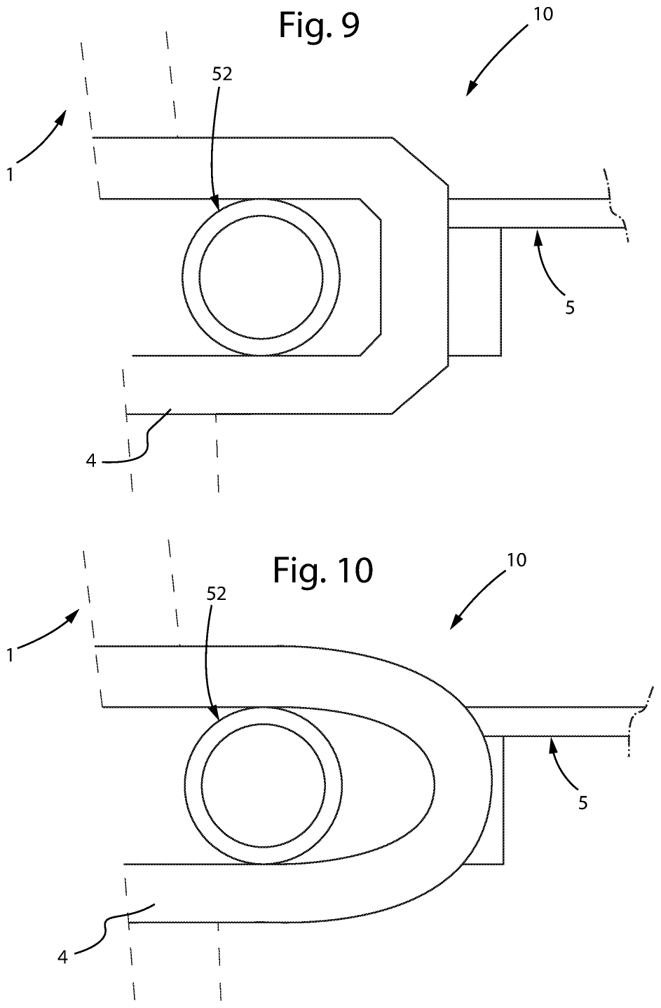

FIG. 9 is a detailed side view of a third variant of the coupling of FIG. 8;

FIG. 10 is a detailed side view of a fourth variant of the coupling of FIG. 8;

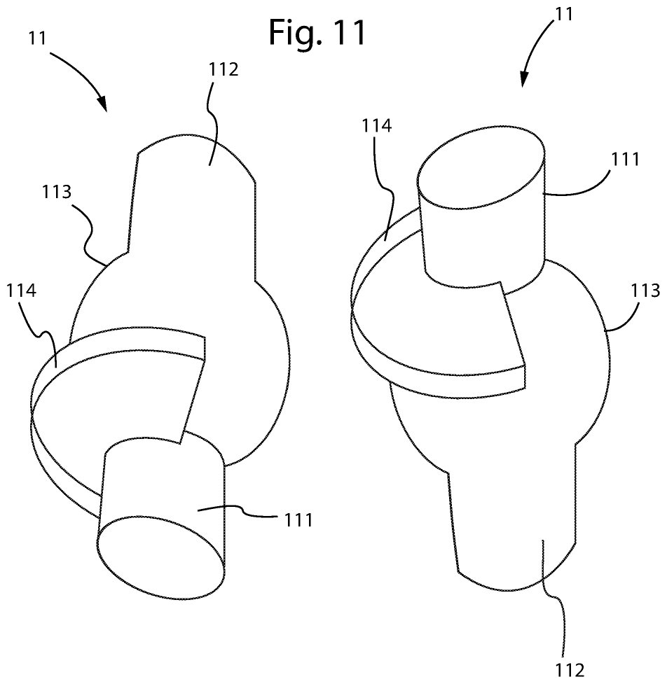

FIG. 11 comprises two views of an alternative embodiment of a pin of the coupling system according to the present invention;

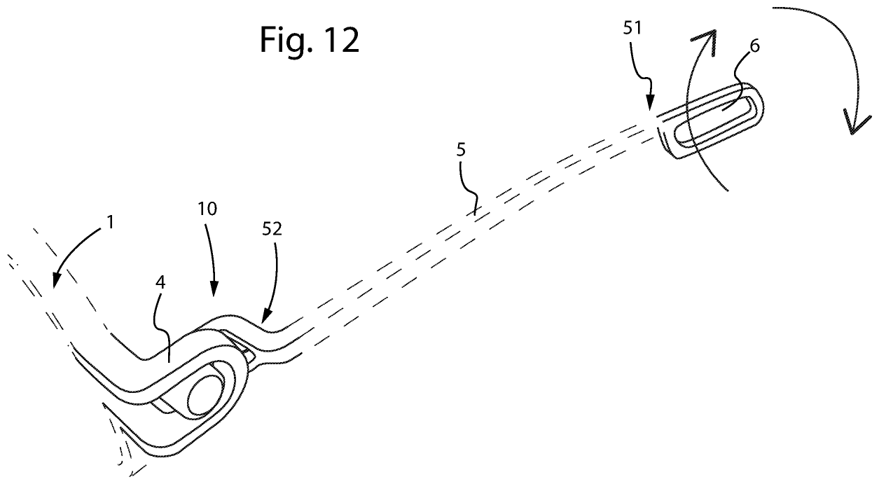

FIG. 12 is a perspective view of a detail of the frame of FIG. 1;

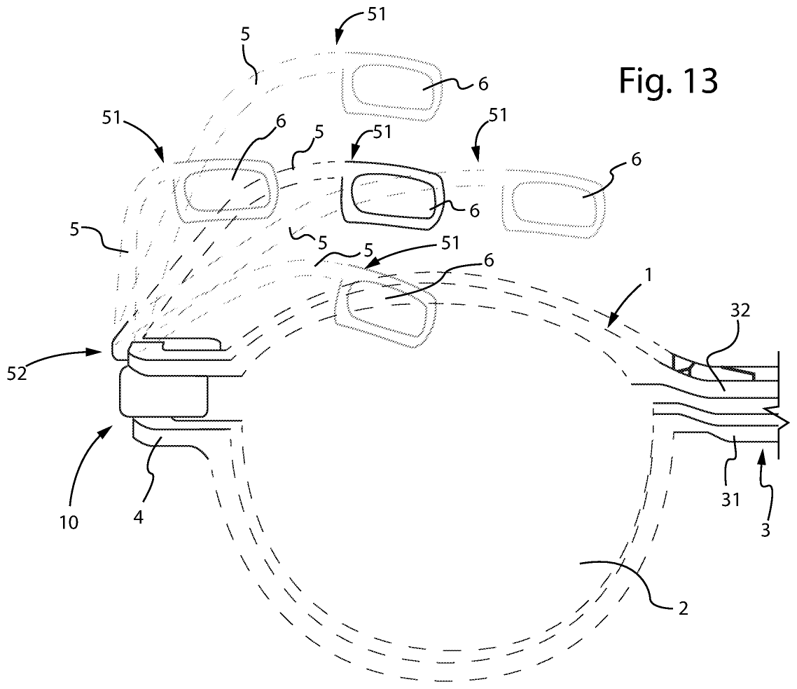

FIG. 13 is a front view of a portion of the frame of FIG. 1, highlighting the possible movement of the stem.

With reference to the figures, a pair of glasses 100 is shown comprising a frontal frame 1, comprising two seats 2 each adapted to receive a sunglasses and/or prescription lens, a bridge 3 and two lateral coupling portions 4. Such lateral coupling portions have, in particular, an essentially C-shape.

In the first embodiment (FIGS. 3-7) the coupling portions 4 of the frontal frame 1, have a substantially rounded C-shape.

However, this is not the only possible embodiment. The C-shaped coupling portion can be oblong (FIG. 8), square (FIG. 9) or elliptical (FIG. 10) in shape.

In the present description, reference will be made to the three directions of a Cartesian plane X, Y, Z shown in FIG. 1.

In the embodiment illustrated, the frontal frame 1 lies substantially in the XY plane illustrated in FIG. 1, while the coupling portions 4 extend from the frontal frame 1 along a direction Z.

The glasses 100 further comprise two stems 5 extending in length and comprising a first end 51 adapted to be hooked to a user's ear and a second end 52 opposite the first end adapted to be coupled to the frontal frame 1. The stems 5 can also comprise on their first end 51 cushion elements 6 to increase the comfort of contact with the user's head.

Further, the second end 52 has a hook shape adapted to be inserted into the coupling portion 4 of the frontal frame 1.

When the stems 5 are coupled to the frontal frame 1 and are in the open position they lie substantially parallel to the direction Z.

According to the present invention, each stem 5 and the frontal frame 1 are coupled by means of a coupling system, collectively referred to as 10.

The coupling system 10 comprises:
a pin 11, made of flexible material and having two opposite ends 111 and 112;
two blind holes 13 made on each of said coupling portions 4 of said frontal frame 1;
a through seat 12 made on the second end 52 of each of said stems 5 adapted to receive said pin 11.

In particular, the second end 52 of each stem 5 including the pin 11 in the appropriate seat 12, is adapted to be inserted in the respective coupling portion 4 of the frontal frame 1 so as to insert the ends of the pin 11 into the blind holes 13 made thereon, by means of the elastic deformation of the pin 11 and/or of the coupling portions 4.

Once the second end 52 of a stem 5 is coupled to the coupling portion 4 of the frontal frame 1, the stem 5 is free to rotate about the axis of the pin 11 allowing the closure on the frontal frame 1, parallel to the direction Y, as highlighted in FIGS. 12 and 13.

Such an aspect is possible by virtue of the complementarity of the second end 52 of the stem 5 with the coupling portion 4.

Advantageously, the coupling system 10 further comprises an elastic element 14 adapted to be interposed between said stems 5 and said frontal frame 1 in an appropriate seat 15 so as to create friction between the two elements and better control the opening and closing movement of the stems 5 on the frontal frame 1.

The elastic element 14 means that a certain amount of force is required to open and close the stems 5 on the frontal frame 1, making the coupling system 10 more solid and effective.

Advantageously, it is also possible to adjust the rotation of the stems about the axis X, at the point of coupling to the frontal frame 1, i.e., on the pin 11, when worn by the user. In fact, it is well known that human ears are not always perfectly aligned, which is why glasses are adjusted and adapted by the optician so that they are positioned straight with respect to the wearer's face.

In this case, by virtue of the possibility of movement of the stem 5 about the axis X at the point of coupling to the frontal frame 1, in particular on the body of the pin 11, as illustrated schematically in FIGS. 7, 12 and 13, it is possible to adjust the inclination of the stem 5 without the need for special equipment. Advantageously, this feature allows a user to adjust the glasses to his or her face, e.g., by looking in the mirror and adjusting them both upon purchase but also later in the event of imbalances due to their use.

Once adapted to the face, the presence of the elastic element 14 and the pin 11 allow to exert a force which ensures that the stems 5 remain in the desired position in relation to the frontal frame 1.

As can be seen in FIG. 3, the pin 11 has a rounded central portion 113 between the two ends 111 and 112.

The rounded central portion 113 advantageously allows the stem 5 to be held in position relative to the frontal frame 1, but at the same time allows the rotation of the stem 5 in both the opening and closing movements thereof, but also in the aforesaid adjustment movements.

Advantageously, the pin 11 can comprise an additional protruding element 114 adapted to increase the friction between the pin 11 itself and the inside of the seat 12, thereby increasing its strength in a fixed position.

FIG. 10 shows a variant of the pin 11, comprising a semi-circular bulge 114.

Preferably the stems 5 and the frontal frame 1 are made of titanium, the pin 11 and the elastic element 14 are made of an elastomer which is 3D printed.

Also forming part of the present invention are glasses 100, comprising a frontal frame 1 and two stems 5, connected to each other by means of the coupling system 10.

Therefore, according to the invention, all the components forming the glasses 100 can be made by 3D printing.

Furthermore, said glasses 100 comprise a bridge 3 having an internally hollow structure 31, 32. As visible in FIGS. 1 and 2, the bridge 3 is made of two portions in which a first portion 31 is connected to the lower portion of the frontal frame 1 and a second portion is connected to the upper portion of the frontal frame 1. In particular, the first 31 and the second 32 portions are detached from each other. Such a configuration reduces the weight of the frontal frame 1 but also makes it easier to insert the lenses into the seats 2.

The operation of the coupling system is clear and obvious from what has been described.

From the above description the features of the system object of the present invention, as well as the advantages thereof, are evident.

Finally, it is clear that the system thus conceived is susceptible to many modifications and variants, all falling within the same inventive concept; furthermore, all details can be replaced by equivalent technical elements. In practice, the materials used, as well as their dimensions, can be of any type according to the technical requirements.

1. A coupling system for coupling a frontal frame and two stems of glasses wherein:
the frontal frame comprises two seats each suitable for receiving a lens, a bridge, and two lateral coupling portions; and
the stems extend in length, each comprising a first end able to be hooked to the ear of a user and a second end opposite the first end able to be coupled to the frontal frame via the coupling portions;
the coupling system comprising:
for each of the stems, a pin made of flexible material and having two opposite ends;
two blind holes made on each of the coupling portions of the frontal frame; and
a through seat made on the second end of each of the stems adapted to receive the pin;
wherein the second end of each stem including the pin in the respective seat, is adapted to be inserted in the respective coupling portion of the frontal frame so the ends of the pin inserted into the blind holes made therein by elastic deformation of the pin and/or of the coupling portions.

2. The coupling system according to claim 1, wherein the lateral coupling portions are substantially C-shaped.

3. The coupling system according to claim 1, comprising an elastic element able to be interposed between the stems and the frontal frame in a suitable seat so as to create friction between the two elements and better control opening and closing movement of the stems on the frontal frame.

4. The coupling system according to claim 1, wherein the second end of each stem has a hook shape suitable to be inserted in the coupling portion of the frontal frame.

5. The coupling system according to claim 1, wherein all components of the coupling system are made by 3D printing.

6. The coupling system according to ene claim 1, wherein the pin has two ends and a rounded central portion.

7. The coupling system according to claim 1, wherein the pin has an additional protruding element designed to increase friction between the pin and the through seat.

8. Glasses comprising a frontal frame, and two stems wherein the frontal frame and the stems are coupled by the coupling system according to claim 1.

9. The glasses according to claim 8, wherein the stems and the frontal frame comprise titanium, and the pin and the elastic element comprise an elastomer which is 3D printed.

10. The glasses according to claim 8, comprising a bridge having an internally hollow structure.
